(19) United States
(12) Patent Application Publication
(10) Pub. No.: US 2024/0388166 A1
(43) Pub. Date: Nov. 21, 2024

(54) BALANCING DISK FOR MOTOR, ROTOR ASSEMBLY, MOTOR AND VEHICLE

(71) Applicant: XIAOMI EV TECHNOLOGY CO., LTD., Beijing (CN)

(72) Inventor: Xuan LUO, Beijing (CN)

(21) Appl. No.: 18/379,530

(22) Filed: Oct. 12, 2023

(30) Foreign Application Priority Data
May 17, 2023 (CN) 202310558768.X

(51) Int. Cl. H02K 7/04; H02K 1/276; H02K 9/19

(52) U.S. Cl. CPC H02K 7/04; H02K 1/276; H02K 9/19

(57) ABSTRACT

A balancing disk has an oil discharge port, and a first end face and a second end face opposite to each other, the first end face is configured to fit on an end face of a rotor core, the second end face has an annular groove, and the oil discharge port is communicated with the first end face and the annular groove, to enable oil flowing out of the oil discharge port to be discharged through the annular groove.

### CROSS-REFERENCE TO RELATED APPLICATIONS

The present application claims the benefit of priority to Chinese Application No. 202310558768.X, filed on May 17, 2023, the contents of which are incorporated herein by reference in their entireties for all purposes.

### BACKGROUND

In the related art, for oil cooling of motors, it is generally designed to employ that oil runs through a rotor assembly of the motor. The mainstream solution is to provide an oil channel in a rotating shaft, and the oil is sprayed to a stator winding from a balancing disk through an oil path formed by the balancing disk and an iron core, to complete cooling of the rotor assembly.

### SUMMARY

The disclosure relates to the field of motor technology, and particularly to a balancing disk for a motor, a rotor assembly, a motor and a vehicle.

According to a first aspect of embodiments of the disclosure, there is provided a balancing disk for a motor. The balancing disk includes an oil discharge port, and a first end face and a second end face opposite to each other. The first end face is configured to fit on an end face of a rotor core, the second end face has an annular groove, and the oil discharge port is communicated with the first end face and the annular groove, to enable oil flowing out of the oil discharge port to be discharged through the annular groove.

According to a second aspect of embodiments of the disclosure, there is provided a rotor assembly, including a rotor core, a rotating shaft and two balancing disks. The two balancing disks and the rotor core are fitted over the rotating shaft, and the two balancing disks are respectively arranged at two ends of the rotor core in an axial direction. Each of the balancing disks includes an oil discharge port, and a first end face and a second end face opposite to each other. The first end face is configured to fit on an end face of a rotor core, the second end face has an annular groove, and the oil discharge port is communicated with the first end face and the annular groove, to enable oil flowing out of the oil discharge port to be discharged through the annular groove.

According to a third aspect of embodiments of the disclosure, there is provided a motor, including a rotor assembly. The rotor assembly includes a rotor core, a rotating shaft and two balancing disks. The two balancing disks and the rotor core are fitted over the rotating shaft, and the two balancing disks are respectively arranged at two ends of the rotor core in an axial direction. Each of the balancing disks includes an oil discharge port, and a first end face and a second end face opposite to each other. The first end face is configured to fit on an end face of a rotor core, the second end face has an annular groove, and the oil discharge port is communicated with the first end face and the annular groove, to enable oil flowing out of the oil discharge port to be discharged through the annular groove.

### BRIEF DESCRIPTION OF THE DRAWINGS

The accompanying drawings, which are incorporated in and constitute a part of this specification, illustrate embodiments in line with the present disclosure and, together with the description, serve to explain the principle of the present disclosure.

FIG. 1 is a perspective view illustrating a balancing disk according to an embodiment.

FIG. 2 is a perspective view illustrating a balancing disk from another perspective according to an embodiment.

FIG. 3 is a front view illustrating a balancing disk according to an embodiment, in which a second end face of the balancing disk is shown.

FIG. 4 is a schematic cross-sectional view taken along a line A-A in FIG. 3.

FIG. 5 is a schematic cross-sectional view illustrating a balancing disk according to an embodiment.

FIG. 6 is an enlarged schematic view of a part A in FIG. 1, in which a first sidewall and a third sidewall are schematically separated by a dashed line for clarity.

FIG. 7 is a schematic perspective view illustrating a balancing disk according to an embodiment, in which arrows schematically illustrate paths for oil discharge.

FIG. 8 is a schematic perspective view illustrating a balancing disk according to another embodiment, in which arrows schematically illustrate paths for oil discharge.

FIG. 9 is a schematic front view illustrating a balancing disk according to another embodiment, in which a second end face of the balancing disk is shown.

FIG. 10 is a perspective view illustrating a balancing disk from another perspective according to another embodiment.

FIG. 11 is a rear view illustrating a balancing disk according to another embodiment, in which a first end face of the balancing disk is shown.

FIG. 12 is a rear view illustrating a balancing disk according to yet another embodiment, in which a first end face of the balancing disk is shown.

FIG. 13 is a partial structural schematic diagram illustrating a rotor assembly according to another embodiment, in which a rotor core, a rotating shaft and a magnet unit are shown.

### DESCRIPTION OF THE REFERENCE NUMERALS

100—rotor assembly; 10—balancing disk; 11—first end face; 12—second end face; 13—oil discharge port; 131—third sidewall; 14—annular groove; 141—first sidewall; 142—second sidewall; 143—bottom wall; 151—first oil discharge groove; 152—second oil discharge groove; 153—third oil discharge groove; 154—fourth oil discharge groove; 16—first mounting hole; 161—rotation axis; 20—rotor core; 21—axial through hole; 22—end face of rotor core; 30—rotating shaft; 31—oil hole; 40—magnet unit; 41—magnet.

### DETAILED DESCRIPTION

Embodiments will be described in detail herein, examples of which are illustrated in the accompanying drawings. The following description refers to the accompanying drawings in which the same reference numerals in different drawings represent the same or similar elements unless otherwise represented. The implementations set forth in the following description of the embodiments do not represent all implementations in line with the present disclosure. Instead, they are merely examples of devices and methods in line with aspects related to the present disclosure as recited in the appended claims.

It should be noted that all actions of obtaining signals, information or data in the disclosure are performed under premise of complying with corresponding data protection regulations and policies of the country where it is located and obtaining authorization from the owner of a corresponding device.

In the disclosure, it should be understood that orientations or positional relationships indicated by orientation terms such as “front”, “rear”, “left”, “right”, etc. are the orientations or positional relationships based on the accompanying drawings, and are only for convenience of describing the disclosure and simplifying the description, rather than indicate or imply that the device or element referred to must have a specific orientation, configuration and operation in the specific orientation, and thus should not be construed as a limit on the disclosure. Unless stated to the contrary, terms such as “first” and “second” are used only to distinguish one element from another element and do not imply sequence or importance.

The applicant found that, in the related art, in case that rotating speed of a motor is increased to a certain value, that is, a linear velocity of oil (cooling oil) discharged from an oil discharge port on a rotor core reaches a certain value, a scouring force of the cooling oil will damage a stator of the motor, and service life of the motor is affected.

However, the oil sprayed from the rotor has an increasing scouring force on the stator as a rotating speed increases, so that a scoured part of the stator is damaged. The scoured part of the stator is often an end of the stator, and the part is provided with insulating materials such as impregnating varnish and insulating paper. Service life of the motor will be shortened or terminated in case that the part is damaged.

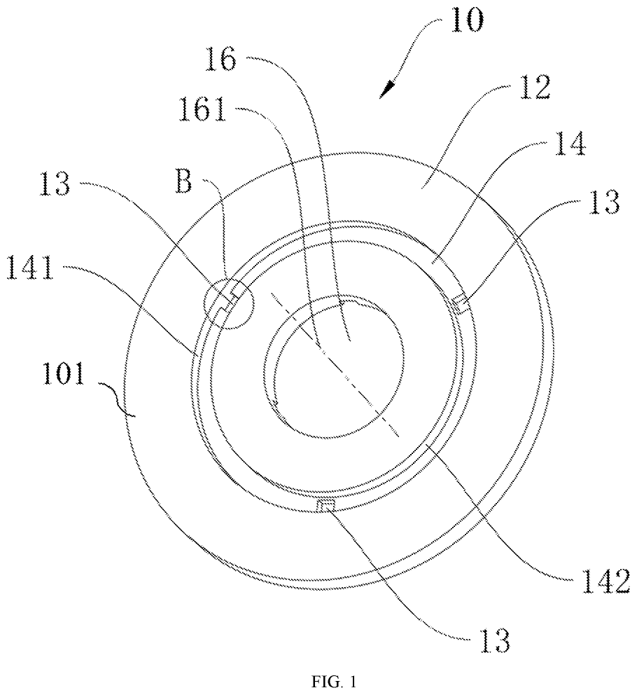

In view of this, as shown in FIGS. 1 to 12, according to a first aspect of the disclosure, there is provided a balancing disk 10 for the motor, which may be a high-speed motor. The balancing disk 10 has an oil discharge port 13, and a first end face 11 and a second end face 12 opposite to each other. The first end face 11 is configured to fit on an end face 22 of a rotor core, the second end face 12 includes a recessed region that defines an annular groove 14, and the oil discharge port 13 is communicated with the first end face 11 and the annular groove 14, to enable oil flowing out of the oil discharge port to be discharged through the annular groove 14. In embodiments, oil discharge port 13 is an aperture through balancing disk 10. The aperture is defined by an interior surface of balancing disk 10 that spans between end face 11 and a location of end face 12, such as annular groove 14. In an example, the balancing disk 10 includes a disk body 101, and the disk body 101 has the oil discharge port 13, the first end face 11 and the second end face 12.

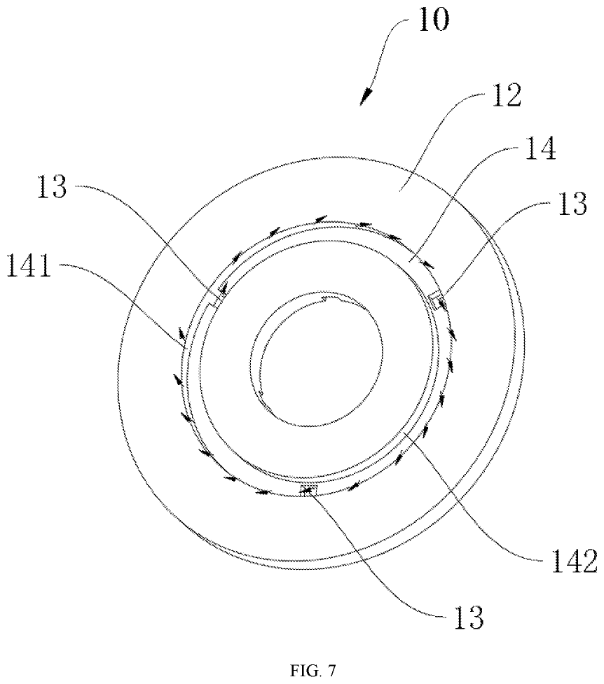

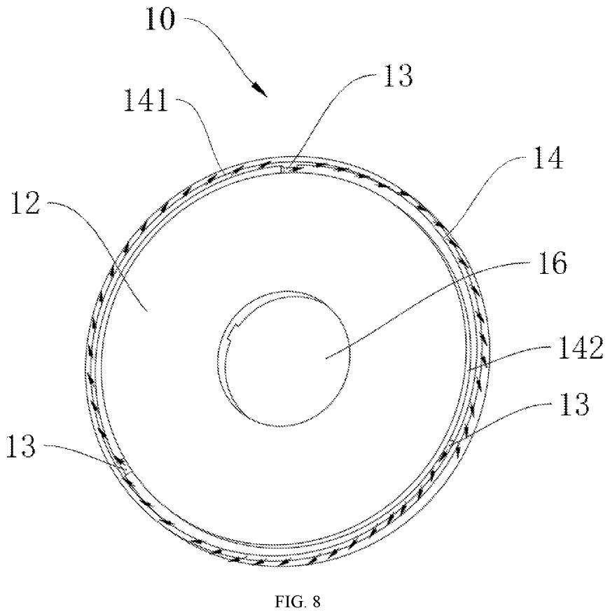

In the balancing disk 10 provided by the disclosure, the annular groove 14 is provided, and the oil (the cooling oil) flowing out from an outlet end of the oil discharge port 13 may enter the annular groove 14. The oil may be dispersed in the annular groove 14 during rotation with the balancing disk 10 around a rotation axis of the balancing disk 10, to change from an oil beam to an oil film. The oil film is thrown out from the annular groove 14 (a direction as shown in FIGS. 7 and 8) under effect of a centrifugal force during rotation of the balancing disk 10, and the oil film is atomized and sprayed towards a stator root of the motor under effect of a high speed, so that a scouring force of the oil may be greatly reduced, reducing a risk of damage caused by scouring of the oil on the stator root, and protecting insulating materials such as impregnating varnish and insulating paper at the stator root, which is beneficial to prolonging the service life of the motor.

Furthermore, a problem of damage to the stator of the motor to increase of the rotating speed of the motor is solved by designing the balancing disk 10, and therefore the rotating speed of the motor may be increased on the premise of protecting the stator, to meet use conditions required for high rotating speed of the motor.

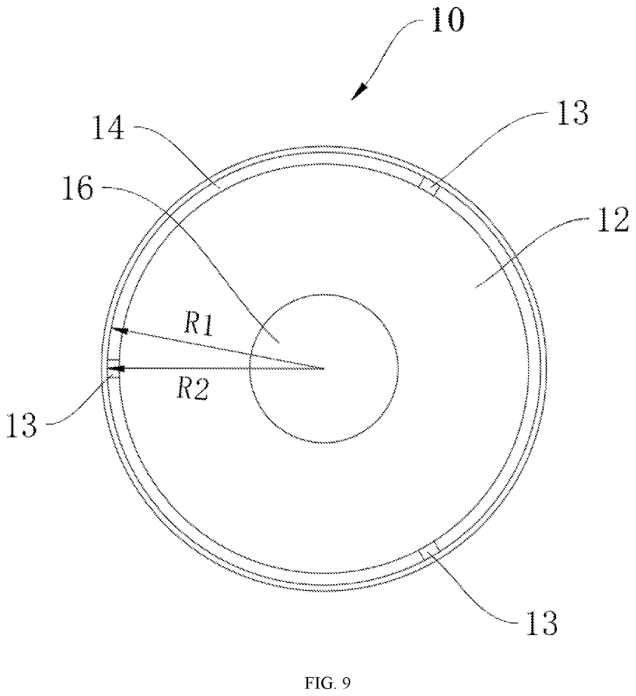

As shown in FIGS. 1 and 8, in some embodiments of the disclosure, the annular groove 14 may be arranged around the rotation axis 161 of the balancing disk 10. The annular groove 14 has a first sidewall 141 a second sidewall 142 spaced apart from each other, and a bottom wall 143 located between the first sidewall 141 and the second sidewall 142. The first sidewall 141 is located outside the second sidewall 142 in a radial direction of the balancing disk 10, and a radial distance between an end of the first sidewall 141 close to the bottom wall 143 and the rotation axis 161 is a first distance (e.g. R1 in FIGS. 3 and 9). The outlet end of the oil discharge port 13 extends to the bottom wall 143 to communicate with the annular groove 14, a radial distance between a third sidewall 131 located at an outermost side in the radial direction of the balancing disk 10 in the oil discharge port 13 and the rotation axis 161 is a second distance (e.g. R2 in FIGS. 3 and 9), and the first distance is greater than or equal to the second distance.

In this way, it is possible to make the oil in the oil discharge port 13 enter the annular groove 14 as much as possible, and to avoid a problem that cooling effect is not ideal and operation of the rotor core 20 is affected due to accumulation of the oil in a gap between the oil discharge port 13 or the balancing disk 10 and the end face 22 of the rotor core.

In the annular groove 14, the oil is mainly blocked by the first sidewall 141 of the annular groove 14. The oil flowing out from the outlet end of the oil discharge port 13 may immediately contact the first sidewall 141 in case that the first distance is equal to the second distance, so that the oil flowing out from the outlet end of the oil discharge port 13 may contact the first sidewall 141 without passing through the bottom wall 143, enabling the oil to enter the annular groove 14 more smoothly, increasing stability of flowing of the oil, and improving an NVH (Noise Vibration and Harshness) problem of the motor.

In the disclosure, the first sidewall 141 may be configured as an outward inclined sidewall or a straight wall in a direction from the first end face 11 toward the second end face 12 of the balancing disk 10, which is not limited by the disclosure. That is, an angle between the first sidewall 141 and the bottom wall 143 of the annular groove 14 is not limited in the disclosure. However, it is considered that the oil may be hold back in the rotor in case that the angle is less than 90 degrees, causing dead oil and affecting heat dissipation of the rotor. Based on this, referring to FIGS. 3 to 5 and 9, the bottom wall 143 is parallel to the first end face 11, and the angle between the first sidewall 141 and the bottom wall 143 is greater than or equal to 90 degrees. In case that the angle between the first sidewall 141 and the bottom wall 143 is greater than 90 degrees, movement of the oil will increase a radial component after the oil enters the annular groove 14, and oil-trapping effect (i.e. oil-guiding effect) will be compromised. In case that the angle between the first sidewall 141 and the bottom wall 143 is equal to 90 degrees, the movement of the oil does not increase a component and the oil-trapping effect is more ideal.

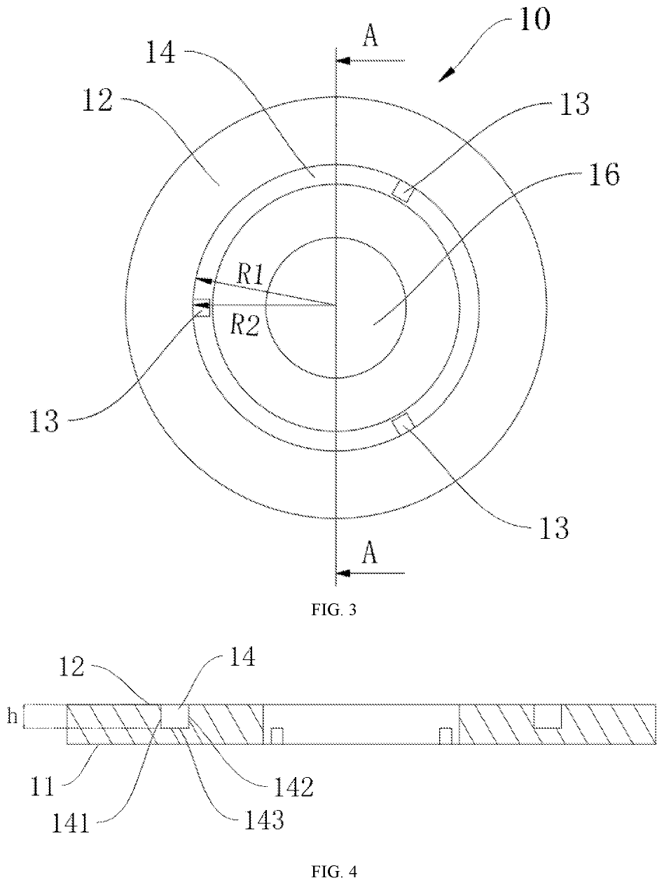

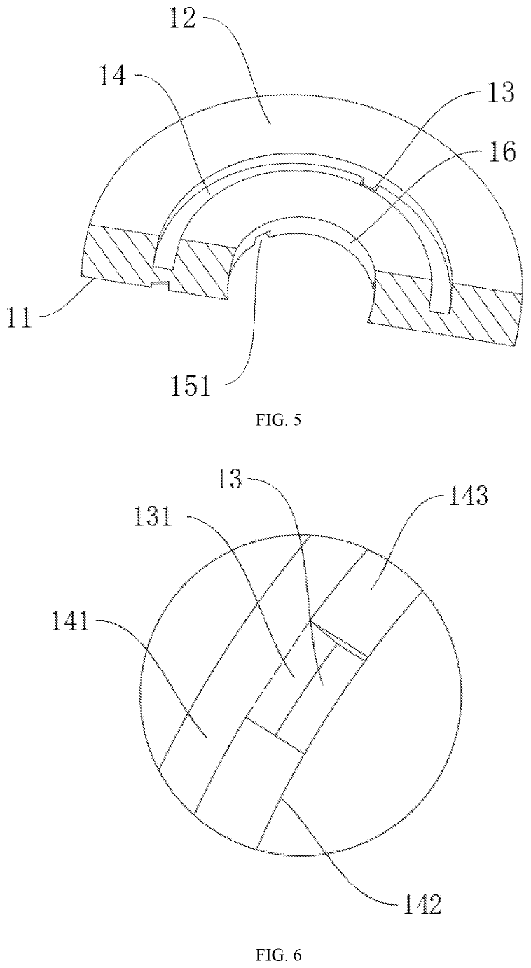

In order to improve the oil-trapping effect of the first sidewall 141 of the annular groove 14, in some examples, as shown in FIGS. 4 and 5, in some embodiments of the disclosure, the angle between the first sidewall 141 and the bottom wall 143 is equal to 90 degrees and a first projection of the first sidewall 141 on the first end face 11 is a circle. In other words, the angle between the first sidewall 141 and the bottom wall 143 of the annular groove 14 is 90 degrees, and the first sidewall 141 is also configured as a circular arc-shaped sidewall around the rotation axis 161 of the balancing disk 10. Such a design is beneficial to improving a smooth movement of the oil within the annular groove 14 and, therefore, to improving the oil-trapping effect of the first sidewall 141 of the annular groove 14, facilitating increased residence time of the oil in the annular groove 14 and reducing the scouring force of the oil acting on the stator of the motor. In this case, as shown in FIGS. 3 and 9, the first distance has a size of R1 and the second distance has a size of R2.

In the disclosure, an angle between the second sidewall 142 and the bottom wall 143 is not limited. In some examples, as shown in FIGS. 4 and 8, in some embodiments of the disclosure, the angle between the second sidewall 142 and the bottom wall 143 is equal to 90 degrees, and a second projection of the second sidewall 142 on the first end face 11 is a circle, where a center of the first projection may coincide with a center of the second projection. The angle between the second sidewall 142 and the bottom wall 143 is designed to be 90 degrees, which facilitates processing of the annular groove 14, and is beneficial to increasing the residence time of the oil in the annular groove 14, so that the oil is distributed more uniformly in an oil-trapping groove.

In the disclosure, on the basis of ensuring structural strength of the balancing disk 10, referring to FIG. 4, a size of a depth h of the annular groove 14 (i.e., an axial size of the annular groove 14) may be increased as much as possible, because the larger the depth h is, the more uniformly the oil is distributed in the annular groove 14, and the more obvious the effect of reducing the flushing force is.

In order to further improve the oil-trapping effect of the balancing disk 10, in some examples, referring to FIG. 6, the first projection of the first sidewall 141 on the first end face 11 is a circle, the third sidewall 131 of the oil discharge port 13 is an arc-shaped sidewall, a projection of the arc-shaped sidewall on the first end face 11 is an arc-shaped segment, and the third sidewall 131 is flush with the first sidewall 141 in the radial direction of the balancing disk 10. In other words, a radius of curvature of the arc-shaped segment is the same as a radius of curvature of the first projection. In this way, the oil flowing out of the oil discharge port 13 in a rotating state may be directly guided by the first sidewall 141 of the annular groove 14, and an additional radial component force may be not added, so that a better oil-trapping effect may be obtained.

To facilitate the oil discharge from the oil discharge port 13, the oil is prevented from accumulating in the oil discharge port 13. In some examples, in the disclosure, a caliber of the oil discharge port 13 may gradually increase from an inlet end to the outlet end of the oil discharge port 13, i.e., the oil discharge port 13 is an opening flared toward the second end face 12.

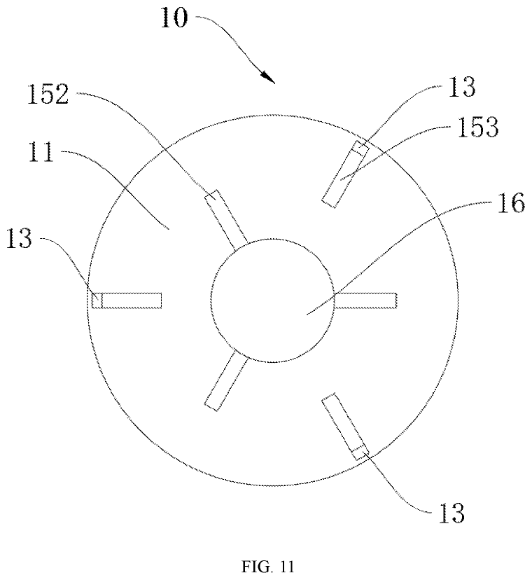

The number of the oil discharge ports 13 is not limited in the disclosure. In order to improve oil discharge efficiency and effect, in some examples, as shown in FIGS. 3 and 11, a plurality of oil discharge ports 13 is provided, and the plurality of oil discharge ports 13 is arranged at equal angular intervals in a circumferential direction around the rotation axis 161 of the balancing disk 10. In this way, reasonable design of the number and position of the oil discharge ports 13 is beneficial to balance of oil injection of the balancing disk 10, further improving NVH performance of the motor.

A position of the annular groove 14 in the radial direction of the balancing disk 10 is not limited in the disclosure. In some examples, in one embodiment of the disclosure, as shown in FIG. 3, the annular groove 14 is located in a middle of the balancing disk 10 in the radial direction of the balancing disk 10, and in another embodiment of the disclosure, the annular groove 14 is located near an outer circumference (an outer circumference wall) of the balancing disk 10 in the radial direction of the balancing disk 10.

In the related art, the motor is often cooled by adopting a solution of left-right cross circulation oil cooling or non-cross circulation oil cooling (unilateral oil cooling). The solution of the left-right cross circulation oil cooling is that an oil channel is provided on a rotating shaft of the motor, the oil passing through the oil channel passes through oil paths formed by the balancing disk and a first end of the rotor core of the motor, then the cooling oil enters axial through holes (such as lightening holes) extending in an axial direction of the rotor core, flows to a second end from the first end of the rotor core, and finally is sprayed out through an oil spraying hole provided on the balancing disk at the second end, to flow to a stator winding of the motor, so that cooling of the whole rotor assembly is completed.

The solution of the unilateral oil cooling is that the oil channel is provided on the rotating shaft of the motor, the oil passing through the oil channel passes through the oil paths formed by the balancing disks on two sides of the motor and ends of the rotor core respectively, and after the rotor is cooled the oil is sprayed to the stator winding of the motor still from the balancing disk on a side from which the oil entered, so that the cooling of the whole rotor assembly is completed.

The balancing disk 10 provided by the disclosure is suitable for both the solution of the left-right cross circulation oil cooling and the solution of the non-cross circulation oil cooling.

Regarding the solution of the left-right cross circulation oil cooling, as shown in FIGS. 1, 2 and 13, in one embodiment of the disclosure, the balancing disk 10 is further provided with a first oil discharge groove 151 and a first mounting hole 16 configured for the rotating shaft of the motor to pass through, and a central axis of the first mounting hole 16 is the rotation axis 161 of the balancing disk 10. The first oil discharge groove 151 is located on the first end face 11 of the balancing disk 10 and extends in the radial direction of the balancing disk 10, an inner end of the first oil discharge groove 151 is communicated with the first mounting hole 16, and an outer end of the first oil discharge groove 151 is communicated with the axial through hole 21 located on the end face 22 of the rotor core.

It may be understood that the axial through hole 21 on the rotor core 20 here and hereinafter are a through hole communicating two opposite end faces of the rotor core 20. The axial through hole 21 may be a lightening hole of the rotor core 20, or may be a specially arranged through hole, which is not limited in the disclosure.

Based on this, in case that cooling is performed, referring to FIGS. 1 to 3 and 13, the cooling oil may enter a hollow part of the rotating shaft 30 in the axial direction of the motor and then enter between one of the balancing disks 10 of the rotor assembly 100 and a first end of the rotor core 20 through an oil hole 31 in a peripheral wall of the rotating shaft 30; then, the cooling oil may flow from a first end to a second end of the rotor core 20 through the first oil discharge groove 151 and the axial through hole 21 communicating with the first oil discharge groove 151, and be sprayed from the oil discharge port 13 and the annular groove 14 on the balancing disk 10 located at the second end of the rotor core 20, thereby forming left-right cross oil cooling.

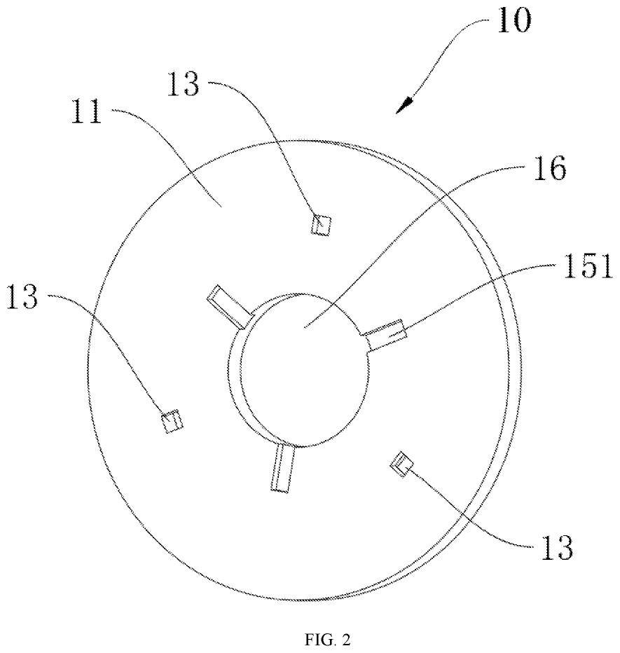

The number and position of the first oil discharge grooves 151 and the oil discharge ports 13 are not limited in the disclosure. In some examples, as shown in FIGS. 1 and 2, in one embodiment of the disclosure, a plurality of first oil discharge grooves 151 and a plurality of oil discharge ports 13 are provided in an equal number, the plurality of first oil discharge grooves 151 and the plurality of oil discharge ports 13 are arranged at equal angular intervals in the circumferential direction around the rotation axis 161, and one oil discharge port 13 is arranged between every two adjacent first oil discharge grooves 151. In this way, reasonable design of the number and position of the first oil discharge grooves 151 and the oil discharge ports 13 is beneficial to balance of oil injection of the rotor assembly 100, and to dynamically balance the motor by the balancing disk 10, further improving the NVH performance of the motor.

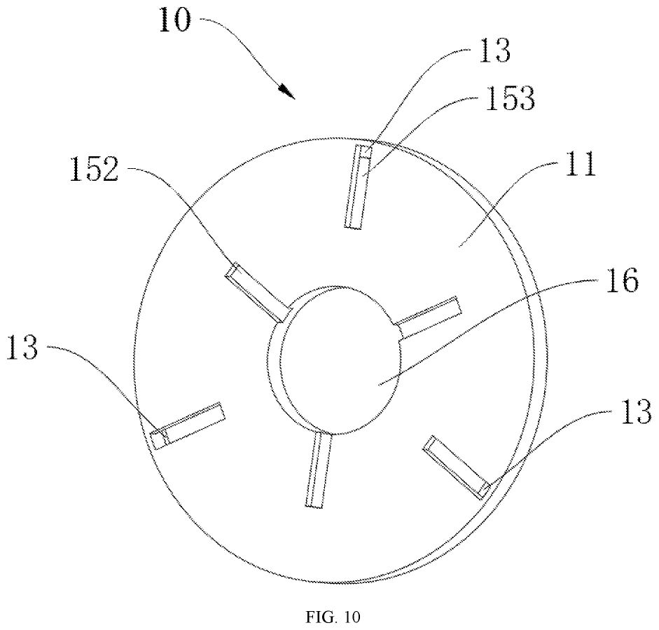

Regarding the solution of the left-right cross circulation oil cooling, as shown in FIGS. 10 and 11, in another embodiment of the disclosure, the balancing disk 10 is further provided with a second oil discharge groove 152, a third oil discharge groove 153 and the first mounting hole 16 configured for the rotating shaft 30 of the motor to pass through. The second oil discharge groove 152 is located on the first end face 11 of the balancing disk 10 and extends in the radial direction of the balancing disk 10, an inner end of the second oil discharge groove 152 is communicated with the first mounting hole 16, and an outer end of the second oil discharge groove 152 is communicated with the axial through hole 21 located on the end face 22 of the rotor core. The third oil discharge groove 153 is located on the first end face 11 of the balancing disk 10 and extends in the radial direction of the balancing disk 10, an inner end of the third oil discharge groove 153 is communicated with another axial through hole 21 located on the end face 22 of the rotor core, and an outer end of the third oil discharge groove 153 is communicated with the inlet end of the oil discharge port 13.

Based on this, in case that cooling is performed, referring to FIGS. 10, 11 and 13, the cooling oil may enter the hollow part of the rotating shaft 30 in the axial direction of the motor and then enter between one of the balancing disks 10 of the rotor assembly 100 and the first end of the rotor core 20 through the oil hole 31 in the peripheral wall of the rotating shaft 30; then, the cooling oil may flow from the first end to the second end of the rotor core 20 through the second oil discharge groove 152 and the axial through hole 21 communicating with the second oil discharge groove 152, and flow to the third oil discharge groove 153 on the balancing disk 10 located at the other end of the rotor core 20, and then be sprayed from the oil discharge port 13 and the annular groove 14 communicating with the third oil discharge groove 153, forming the left-right cross oil cooling.

The number and position of the second oil discharge grooves 152, the third oil discharge grooves 153 and the oil discharge ports 13 are not limited in the disclosure. In some examples, as shown in FIGS. 10 and 11, in one embodiment of the disclosure, a plurality of second oil discharge grooves 152, a plurality of third oil discharge grooves 153 and a plurality of oil discharge ports 13 are provided in an equal number, and the plurality of third oil discharge grooves 153 are in one-to-one correspondence with the plurality of oil discharge ports 13 in terms of position. The plurality of second oil discharge grooves 152 and the plurality of third oil discharge grooves 153 are arranged at equal angular intervals in the circumferential direction around the rotation axis 161, and one second oil discharge groove 152 is arranged between every two adjacent third oil discharge grooves 153. In this way, reasonable design of the number and position of the second oil discharge grooves 152, the third oil discharge grooves 153 and the oil discharge ports 13 is beneficial to the balance of the oil injection of the rotor assembly 100, and to dynamically balance the motor by the balancing disk 10, further improving the NVH performance of the motor.

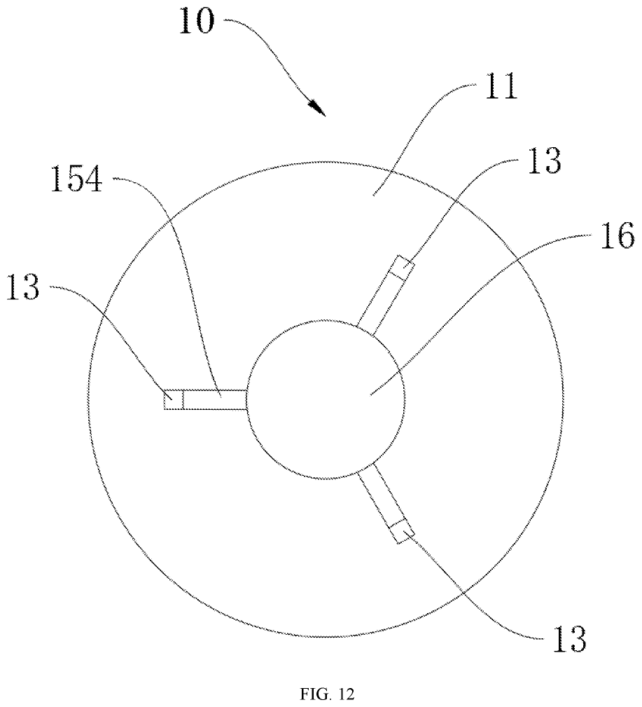

Regarding the solution of the non-cross circulation oil cooling, in some examples, referring to FIG. 12, in one embodiment of the disclosure, the balancing disk 10 is further provided with a fourth oil discharge groove 154 and the first mounting hole 16 configured for the rotating shaft 30 of the motor to pass through. The fourth oil discharge grooves is located on the first end face 11 of the balancing disk 10 and extends in the radial direction of the balancing disk 10, an inner end of the fourth oil discharge groove 154 is communicated with the first mounting hole 16, and an outer end of the fourth oil discharge groove 154 is communicated with the inlet end of the oil discharge port 13.

In case that the motor is cooled, the cooling oil enters oil discharge channels formed by the two balancing disks 10 and the rotor core 20 respectively from the oil channel on the rotating shaft 30 through the oil hole 31, and the cooling oil may be discharged from the fourth oil discharge groove 154, the oil discharge port 13 and the annular groove 14 on the balancing disks 10.

According to another aspect of the disclosure, the rotor assembly 100 is provided. The rotor assembly 100 includes the rotor core 20, the rotating shaft 30, and two balancing disks 10 as described above. The two balancing disks 10 and the rotor core 20 are fitted over the rotating shaft 30, and the two balancing disks 10 are respectively arranged at two ends of the rotor core 20 in an axial direction.

The rotating shaft 30 penetrates through the first mounting hole 16 on the balancing disk 10 and a second mounting hole on the rotor core 20. The rotating shaft 30 may be hollow, and oil hole 31 is through the sidewall of the rotating shaft 30. In case that the cooling is performed, the cooling oil may enter the hollow part of the rotating shaft 30 in the axial direction of the motor, and then enter the oil channel configured by the balancing disk 10 and the rotor core 20 of the rotor assembly 100 through the oil hole 31 on the peripheral wall of the rotating shaft 30.

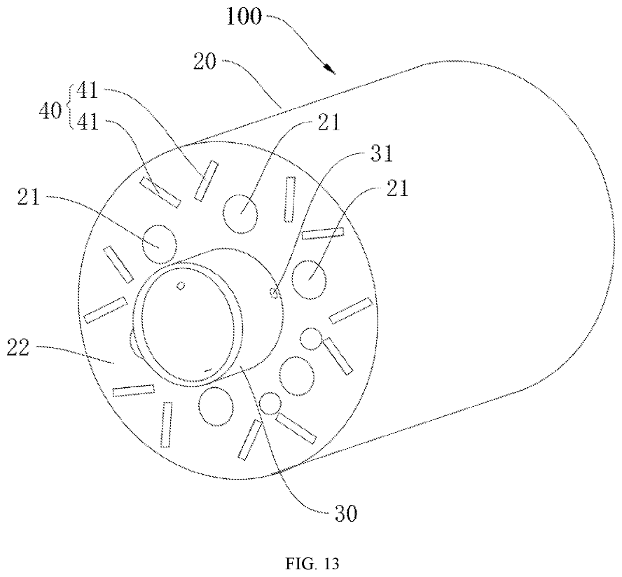

As shown in FIG. 13, the rotor assembly 100 may include a plurality of magnet units 40, two corresponding magnet units 40 are configured as a magnetic pole pair, and the plurality of magnet units 40 is arranged on the end face 22 of the rotor core at equal intervals around a central axis of the second mounting hole.

As an alternative embodiment, referring to FIG. 13, the rotor of the motor has 6 magnet units 40, a number of the magnetic pole pairs is 3, and the 6 magnet units 40 are arranged at equal intervals in the circumferential direction around the central axis of the second mounting hole.

The rotor core 20 and the plurality of magnet units 40 are configured as the rotor of the motor, and the rotor core 20 has a magnet groove that is configured to mount a magnet 41.

According to a third aspect of the disclosure, there is provided the motor including the rotor assembly 100 as described above.

The rotor assembly 100 provided in the disclosure may be a high-speed rotor assembly 100, that is, the motor may be a high-speed motor. An outer sidewall (i.e., an outermost sidewall in the radial direction of the balancing disk 10) of oil discharge port 13 has a linear velocity greater than or equal to 120 m/s in case that the balancing disk 10 rotates. In this way, a problem of damage to the stator of the motor due to increase of the rotating speed of the motor is solved by designing the balancing disk 10, and therefore the rotating speed of the motor may be increased on the premise of protecting the stator, to meet use conditions required for high rotating speed of the motor.

According to a fourth aspect of the disclosure, there is provided a vehicle including the motor as described above. The vehicle may be a hybrid vehicle or a pure-electric new-energy vehicle, and the disclosure is not limited thereto.

According to a first aspect of embodiments of the disclosure, there is provided a balancing disk for a motor. The balancing disk has an oil discharge port, and a first end face and a second end face opposite to each other; and the first end face is configured to fit on an end face of a rotor core, the second end face has an annular groove, and the oil discharge port is communicated with the first end face and the annular groove, to enable oil flowing out of the oil discharge port to be discharged through the annular groove.

In some examples, the annular groove is arranged around a rotation axis of the balancing disk; the annular groove has a first sidewall and a second sidewall spaced apart from each other, and a bottom wall located between the first sidewall and the second sidewall, the first sidewall is located outside the second sidewall in a radial direction of the balancing disk, and a radial distance between an end of the first sidewall close to the bottom wall and the rotation axis is a first distance; an outlet end of the oil discharge port extends to the bottom wall, and a radial distance between a third sidewall located at an outermost side in the radial direction of the balancing disk in the oil discharge port and the rotation axis is a second distance; and the first distance is greater than or equal to the second distance.

In some examples, the bottom wall is parallel to the first end face; and an angle between the first sidewall and the bottom wall is greater than or equal to 90 degrees.

In some examples, a first projection of the first sidewall on the first end face is a circle, and the third sidewall in the oil discharge port is an arc-shaped sidewall; and the third sidewall is flush with the first sidewall in the radial direction of the balancing disk.

In some examples, a caliber of the oil discharge port gradually increases from an inlet end to an outlet end of the oil discharge port.

In some examples, a plurality of the oil discharge ports is provided, and the plurality of the oil discharge ports is arranged at equal angular intervals in a circumferential direction around a rotation axis of the balancing disk.

In some examples, the annular groove is located in a middle of the balancing disk in a radial direction of the balancing disk, or the annular groove is located near an outer circumference of the balancing disk in the radial direction of the balancing disk.

In some examples, the balancing disk is further provided with a first oil discharge groove and a first mounting hole configured for a rotating shaft of the motor to pass through, and a central axis of the first mounting hole is the rotation axis of the balancing disk; and the first oil discharge groove is located on the first end face of the balancing disk and extends in the radial direction of the balancing disk, an inner end of the first oil discharge groove is communicated with the first mounting hole, and an outer end of the first oil discharge groove is configured to be communicated with an axial through hole located on the end face of the rotor core.

In some examples, a plurality of first oil discharge grooves and the plurality of oil discharge ports are provided in an equal number, the plurality of the first oil discharge grooves and the plurality of the oil discharge ports are arranged at equal angular intervals in the circumferential direction around the rotation axis, and one oil discharge port is arranged between every two adjacent first oil discharge grooves.

In some examples, the balancing disk is further provided with a second oil discharge groove, a third oil discharge groove and a first mounting hole configured for a rotating shaft of the motor to pass through, and a central axis of the first mounting hole is the rotation axis of the balancing disk; the second oil discharge groove is located on the first end face of the balancing disk and extends in the radial direction of the balancing disk, an inner end of the second oil discharge groove is communicated with the first mounting hole, and an outer end of the second oil discharge groove is configured to be communicated with an axial through hole located on the end face of the rotor core; and the third oil discharge groove is located on the first end face of the balancing disk and extends in the radial direction of the balancing disk, an inner end of the third oil discharge groove is configured to be communicated with another axial through hole located on the end face of the rotor core, and an outer end of the third oil discharge groove is communicated with the inlet end of the oil discharge port.

In some examples, a plurality of the second oil discharge grooves, a plurality of the third oil discharge grooves and a plurality of the oil discharge ports are provided in an equal number, and the plurality of the third oil discharge grooves is in one-to-one correspondence with the plurality of the oil discharge ports; and the plurality of the second oil discharge grooves and the plurality of the third oil discharge grooves are arranged at equal angular intervals in the circumferential direction around the rotation axis, and one second oil discharge groove is arranged between every two adjacent third oil discharge grooves.

In some examples, the balancing disk is further provided with a fourth oil discharge groove and a first mounting hole configured for a rotating shaft of the motor to pass through, and a central axis of the first mounting hole is the rotation axis of the balancing disk; and the fourth oil discharge groove is located on the first end face of the balancing disk and extends in the radial direction of the balancing disk, an inner end of the fourth oil discharge groove is communicated with the first mounting hole, and an outer end of the fourth oil discharge groove is communicated with the inlet end of the oil discharge port.

According to a second aspect of embodiments of the disclosure, there is provided a rotor assembly, including a rotor core, a rotating shaft and two balancing disk as described above. The two balancing disks and the rotor core are fitted over the rotating shaft, and the two balancing disks are respectively arranged at two ends of the rotor core in an axial direction.

In some examples, an outer sidewall of the oil discharge port has a linear velocity greater than or equal to 120 m/s during rotation of the balancing disk.

According to a third aspect of embodiments of the disclosure, there is provided a motor, including a rotor assembly as described above.

According to a fourth aspect of embodiments of the disclosure, there is provided a vehicle, including a motor as described above.

Other embodiments of the disclosure will be apparent to those skilled in the art from consideration of the specification and practice of the disclosure disclosed here. This application is intended to cover any variations, uses, or adaptations of the disclosure following the general principles thereof and including such departures from the disclosure as come within known or customary practice in the art. It is intended that the specification and examples be considered as explanatory only.

It will be appreciated that the disclosure is not limited to the exact construction that has been described above and illustrated in the accompanying drawings, and that various modifications and changes can be made without departing from the scope thereof. It is intended that the scope of the disclosure only be limited by the appended claims.

What is claimed is:

1. A balancing disk for a motor, comprising:
an oil discharge port; and
a first end face and a second end face opposite to each other,
wherein the first end face is configured to fit on an end face of a rotor core, the second end face has an annular groove, and the oil discharge port is communicated with the first end face and the annular groove, to enable oil flowing out of the oil discharge port to be discharged through the annular groove.

2. The balancing disk of claim 1, wherein the annular groove is arranged around a rotation axis of the balancing disk;
the annular groove has a first sidewall and a second sidewall spaced apart from each other, and a bottom wall located between the first sidewall and the second sidewall, the first sidewall is located outside the second sidewall in a radial direction of the balancing disk, and a radial distance between an end of the first sidewall close to the bottom wall and the rotation axis is a first distance;
an outlet end of the oil discharge port extends to the bottom wall, and a radial distance between a third sidewall located at an outermost side in the radial direction of the balancing disk in the oil discharge port and the rotation axis is a second distance; and
the first distance is greater than or equal to the second distance.

3. The balancing disk of claim 2, wherein the bottom wall is parallel to the first end face; and
an angle between the first sidewall and the bottom wall is greater than or equal to 90 degrees.

4. The balancing disk of claim 3, wherein a first projection of the first sidewall on the first end face is a circle, and the third sidewall in the oil discharge port is an arc-shaped sidewall; and
the third sidewall is flush with the first sidewall in the radial direction of the balancing disk.

5. The balancing disk of claim 4, wherein an angle between the second sidewall and the bottom wall is equal to 90 degrees, a second projection of the second sidewall on the first end face is a circle, and a center of the first projection coincides with a center of the second projection.

6. The balancing disk of claim 1, wherein a size of the oil discharge port gradually increases from an inlet end to an outlet end of the oil discharge port.

7. The balancing disk of claim 1, further comprising a plurality of oil discharge ports, wherein the plurality of the oil discharge ports is arranged at equal angular intervals in a circumferential direction around a rotation axis of the balancing disk.

8. The balancing disk of claim 1, wherein the annular groove is located at a middle of the balancing disk in a radial direction of the balancing disk.

9. The balancing disk of claim 1, wherein the annular groove is located near an outer circumference of the balancing disk in the radial direction of the balancing disk.

10. The balancing disk of claim 1, further comprising a first oil discharge groove and a first mounting hole configured for a rotating shaft of the motor to pass through, wherein a central axis of the first mounting hole is the rotation axis of the balancing disk; and
the first oil discharge groove is located on the first end face of the balancing disk and extends in the radial direction of the balancing disk, the first oil discharge groove has an inner end communicated with the first mounting hole, and an outer end configured to be communicated with an axial through hole located on the end face of the rotor core.

11. The balancing disk of claim 10, wherein a plurality of first oil discharge grooves and a plurality of oil discharge ports are provided in an equal number, the plurality of the first oil discharge grooves and the plurality of the oil discharge ports are arranged at equal angular intervals in the circumferential direction around the rotation axis, and one oil discharge port is arranged between every two adjacent first oil discharge grooves.

12. The balancing disk of claim 1, further comprising a second oil discharge groove, a third oil discharge groove and a first mounting hole configured for a rotating shaft of the motor to pass through, and a central axis of the first mounting hole is the rotation axis of the balancing disk;
the second oil discharge groove is located on the first end face of the balancing disk and extends in the radial direction of the balancing disk, the second oil discharge groove has an inner end communicated with the first mounting hole, and an outer end configured to be communicated with an axial through hole located on the end face of the rotor core; and
the third oil discharge groove is located on the first end face of the balancing disk and extends in the radial direction of the balancing disk, the third oil discharge groove has an inner end configured to be communicated with another axial through hole located on the end face of the rotor core, and an outer end communicated with the inlet end of the oil discharge port.

13. The balancing disk of claim 12, wherein a plurality of the second oil discharge grooves, a plurality of the third oil discharge grooves and a plurality of the oil discharge ports are provided in an equal number, and the plurality of the third oil discharge grooves is in one-to-one correspondence with the plurality of the oil discharge ports in terms of position; and
the plurality of the second oil discharge grooves and the plurality of the third oil discharge grooves are arranged at equal angular intervals in the circumferential direction around the rotation axis, and one second oil discharge groove is arranged between every two adjacent third oil discharge grooves.

14. The balancing disk of claim 1, further comprising a fourth oil discharge groove and a first mounting hole configured for a rotating shaft of the motor to pass through, and a central axis of the first mounting hole is the rotation axis of the balancing disk; and
the fourth oil discharge groove is located on the first end face of the balancing disk and extends in the radial direction of the balancing disk, the fourth oil discharge groove has an inner end communicated with the first mounting hole, and an outer end communicated with the inlet end of the oil discharge port.

15. A rotor assembly, comprising:
a rotor core;
a rotating shaft; and
two balancing disks, each of the two balancing disks comprising:
an oil discharge port, and
a first end face and a second end face opposite to each other,
wherein the first end face is configured to fit on an end face of a rotor core, the second end face has an annular groove, and the oil discharge port is communicated with the first end face and the annular groove, to enable oil flowing out of the oil discharge port to be discharged through the annular groove, and
wherein the two balancing disks and the rotor core are fitted over the rotating shaft, and the two balancing disks are respectively arranged at two ends of the rotor core in an axial direction.

16. The rotor assembly of claim 15, wherein an outer sidewall of the oil discharge port has a linear velocity greater than or equal to 120 m/s during rotation of the balancing disk.

17. The rotor assembly of claim 15, wherein the balancing disk has a first mounting hole, the rotor core has a second mounting hole, and the rotating shaft passes through the first mounting hole and the second mounting hole; and
the rotating shaft is hollow and has an oil hole in a sidewall of the rotating shaft, and the oil hole is communicated with an oil channel defined between the balancing disk of the rotor assembly and the rotor core.

18. The rotor assembly of claim 17, further comprising a plurality of magnet units, wherein two corresponding magnet units are configured as a magnetic pole pair, and the plurality of magnet units is arranged on the end face of the rotor core at equal intervals around a central axis of the second mounting hole.

19. A motor, comprising:
a rotor assembly comprising:
a rotor core;
a rotating shaft; and
two balancing disks, each of the two balancing disks comprising:
an oil discharge port, and
a first end face and a second end face opposite to each other,
wherein the first end face is configured to fit on an end face of a rotor core, the second end face has an annular groove, and the oil discharge port is communicated with the first end face and the annular groove, to enable oil flowing out of the oil discharge port to be discharged through the annular groove, and
wherein the two balancing disks and the rotor core are fitted over the rotating shaft, and the two balancing disks are respectively arranged at two ends of the rotor core in an axial direction.

20. A vehicle, comprising a motor according to claim 19.
